(19) United States
(12) Patent Application Publication
(10) Pub. No.: US 2016/0315583 A1
(43) Pub. Date: Oct. 27, 2016

(54) SOLAR WATER-COLLECTING, AIR-CONDITIONING, LIGHT-TRANSMITTING AND POWER GENERATING HOUSE

(71) Applicant: Farouk DAKHIL, Rome (IT)

(72) Inventor: Farouk DAKHIL, Rome (IT)

(21) Appl. No.: 15/198,850

(22) Filed: Jun. 30, 2016

Related U.S. Application Data
(63) Continuation-in-part of application No. 15/133,337, filed on Apr. 20, 2016.
Application No. 15/133,337 is a division of application No. 14/168,578, filed on Jan. 30, 2014, now Pat. No. 9,350,290.

(51) Int. Cl. H02S 40/44; H02S 40/22

(52) U.S. Cl. CPC H02S 40/44; H02S 40/22

(57) ABSTRACT

A system for collecting solar energy and fresh water may be disclosed. The system may include one or more assemblies of collector modules, each of which module may contain a photovoltaic cell and a thermal fluid. The thermal fluid may be used to heat a building and/or produce electricity. The assembly may further be coupled to a collection shaft which may collect water and/or disseminate light through a building. Various configurations of single modules, single assemblies, or multiple large-scale assemblies are also possible. If integrated with a house, the system may reduce the net energy consumption of the household.

### BACKGROUND

The world's population has already exceeded seven billion people and it continues to grow exponentially higher. By the year 2050 we may reach 9.5 billion people. The needs for drinking water, nutritious food, and clean energy are more urgent than ever before. While the planet's population is increasing, we also continue the pollution of lands, rivers, and oceans through toxic emissions, mainly by burning fossil fuels to power heavy industry and vehicles. Chemicals are discarded into rivers and oceans from industry and agricultural fertilizers. These are the facts of our daily news and contribute to global warming and climate change.

One problem with current centralized power production facilities is the loss of efficiency and therefore additional resources required to send electricity from the power plant to each of the consuming locations, for example a multitude of households. A similar problem is faced by water utilities; fresh water must be located, treated in a central location, and then pumped to the many locations in which it is to be used.

A solution is needed which can increase self-sufficiency. In particular, the costs of producing energy and clean water heavily tax the environment; there is a need for a low-cost method for meeting those needs on a mass scale.

### SUMMARY

According to at least one exemplary embodiment, a system for collecting solar energy and fresh water may be disclosed. The system may include one or more assemblies of collector modules, each of which module may contain a photovoltaic cell and a thermal fluid. The thermal fluid may be used to heat a building and/or produce electricity. The assembly may further be coupled to a collection shaft which may collect water and/or disseminate light through a building. Various configurations of single modules, single assemblies, or multiple large-scale assemblies are also possible. If integrated with a house, the system may reduce the net energy consumption of the household.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

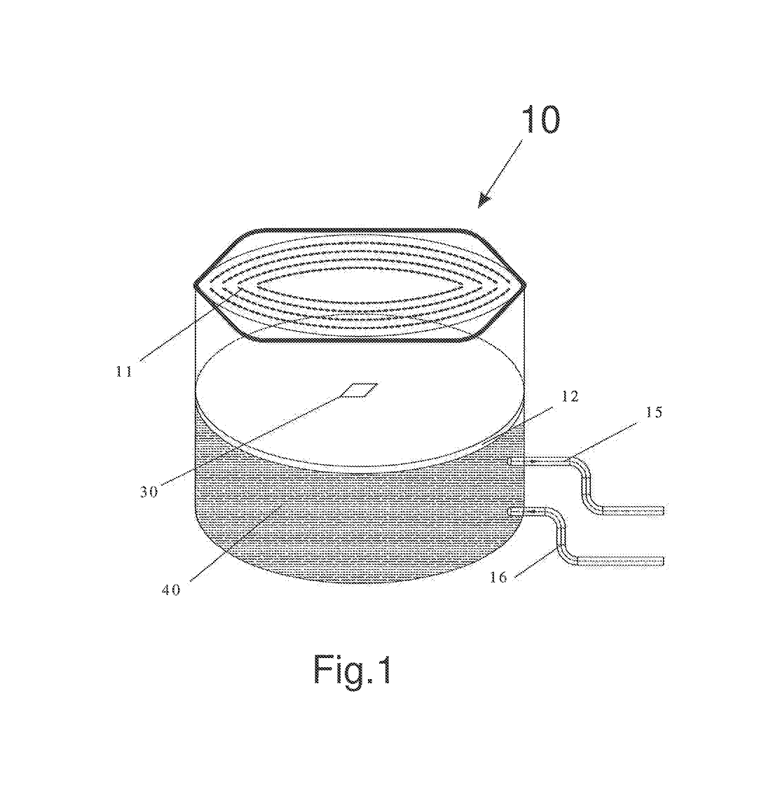

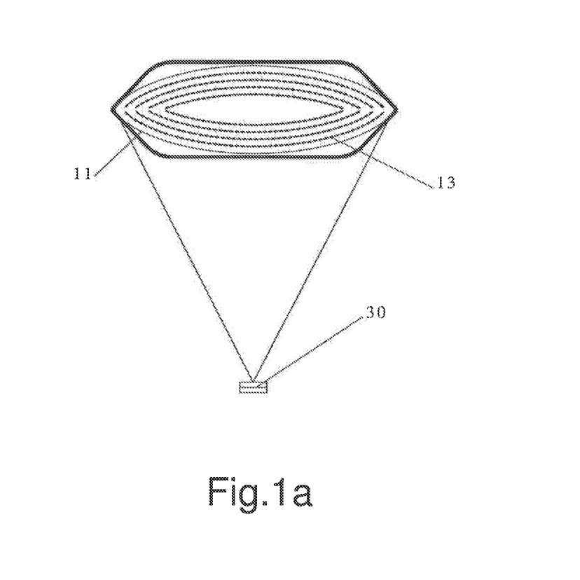

Exemplary FIG. 1 shows a perspective view of a collector module for solar energy.

Exemplary FIG. 1a shows a detailed view of the location of a photovoltaic cell in relation to a concentrating lens of a collector module for solar energy.

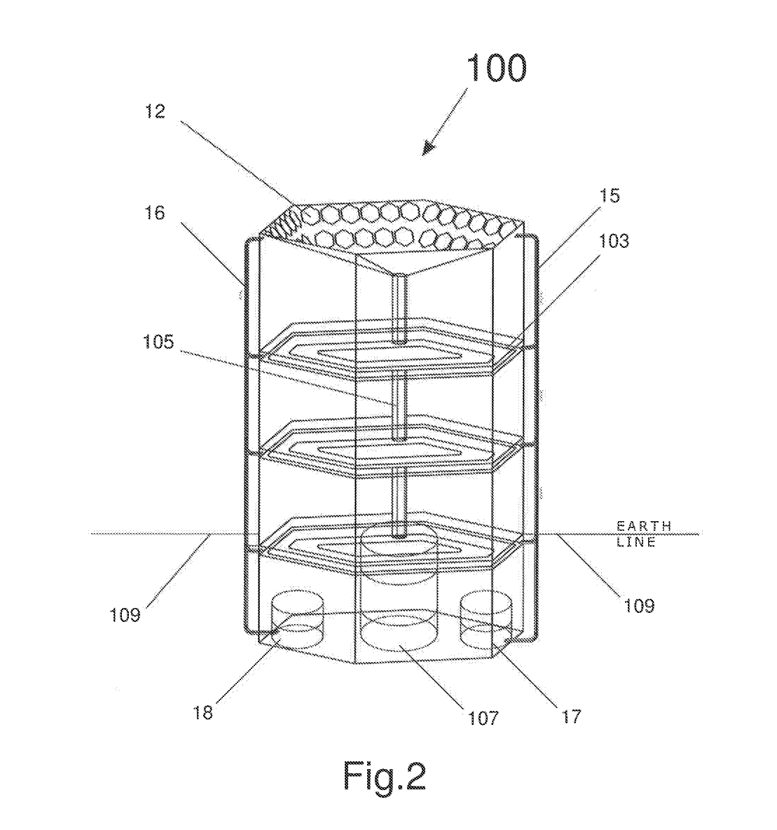

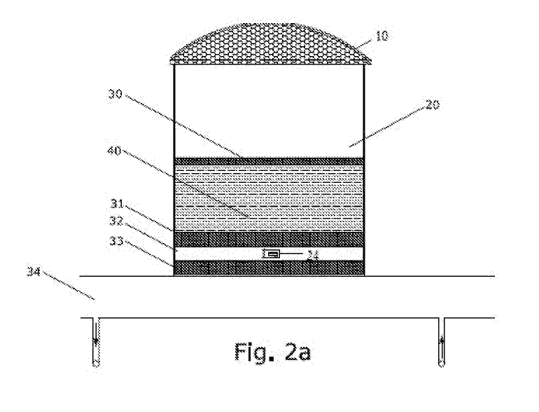

Exemplary FIG. 2 shows a solar house incorporating a plurality of collector modules.

Exemplary FIG. 2a shows a solar house incorporating a plurality of collector modules.

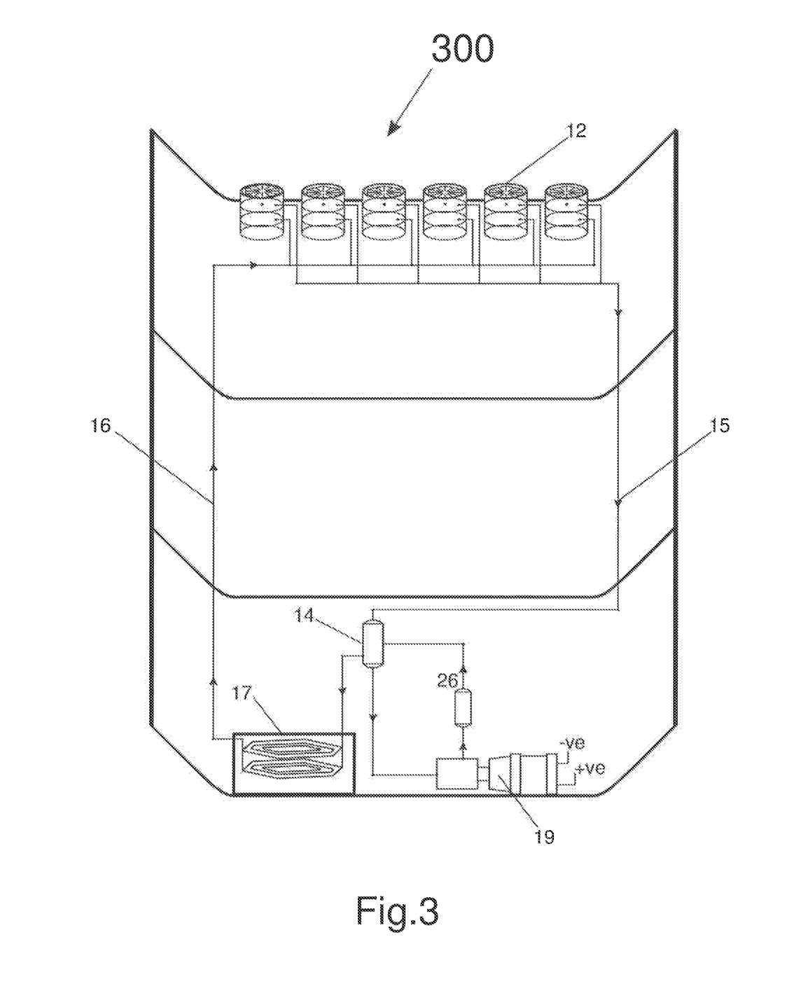

Exemplary FIG. 3 shows a schematic diagram of a thermal fluid system connected to multiple collector modules.

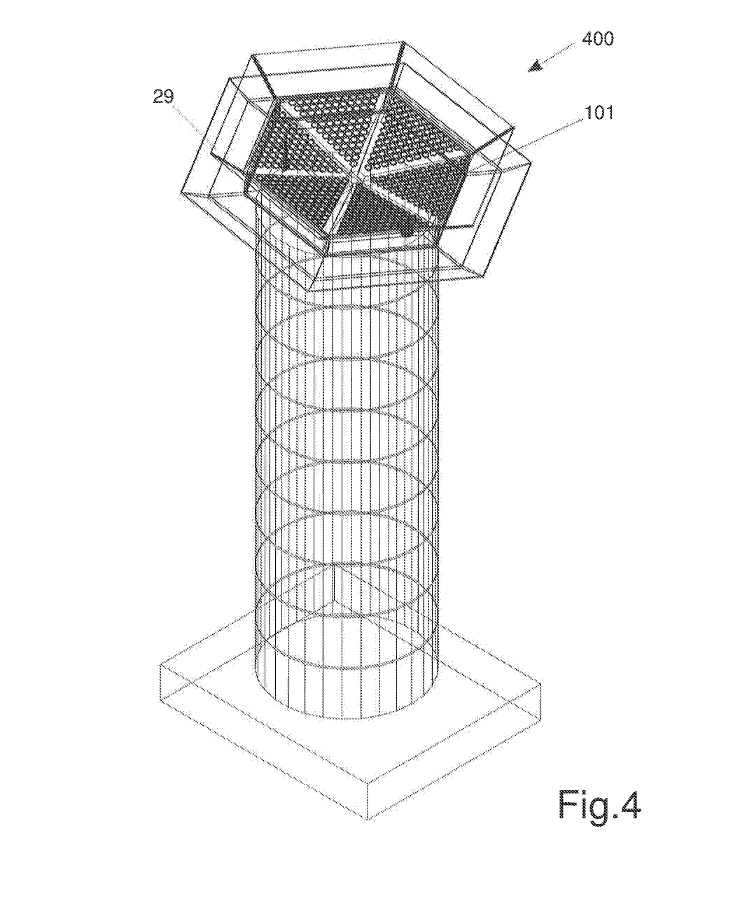

Exemplary FIG. 4 shows an assembly of collector modules on the roof of a building coupled to a system of reflective mirrors.

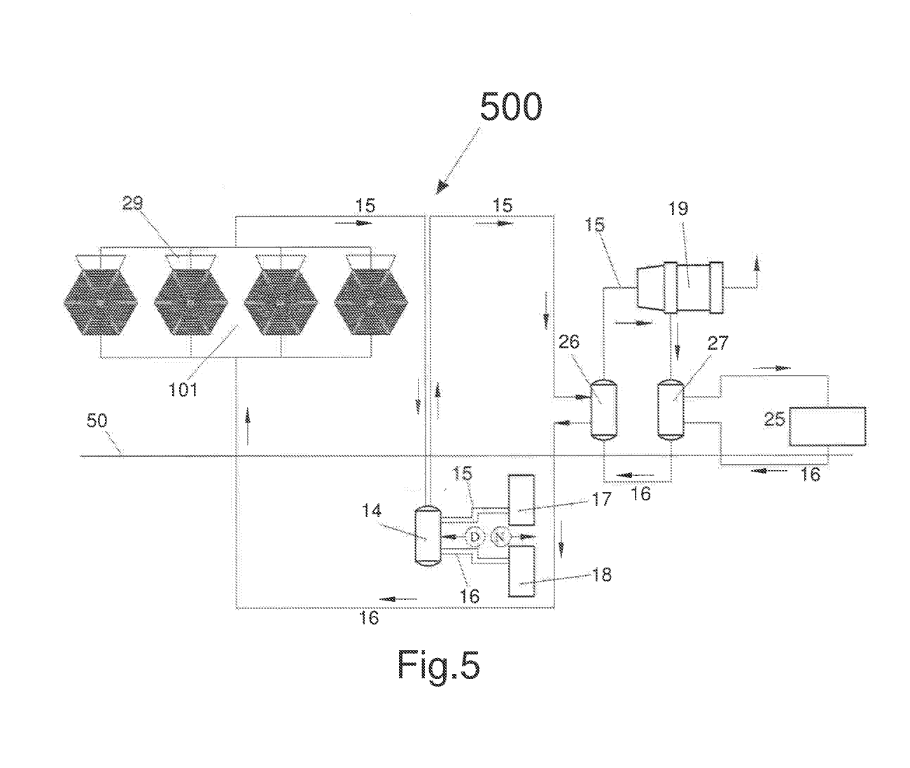

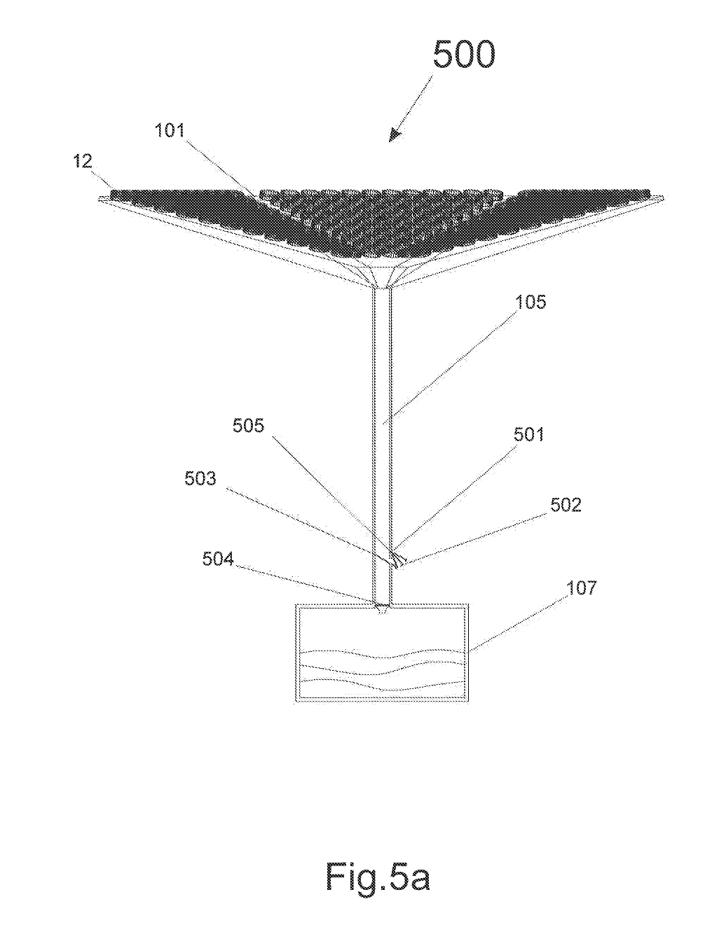

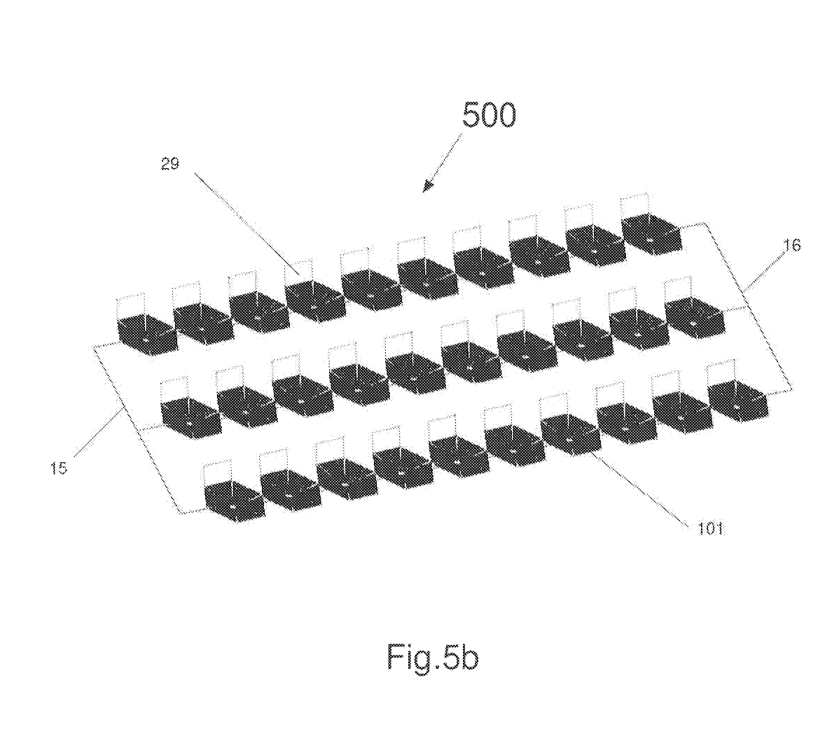

Exemplary FIG. 5 shows a schematic diagram of a field system incorporating multiple assemblies of collector modules.

Exemplary FIG. 5a shows a single assembly of collector modules coupled to a water collection tank.

Exemplary FIG. 5b shows a perspective view of a field system incorporating multiple assemblies of collector modules.

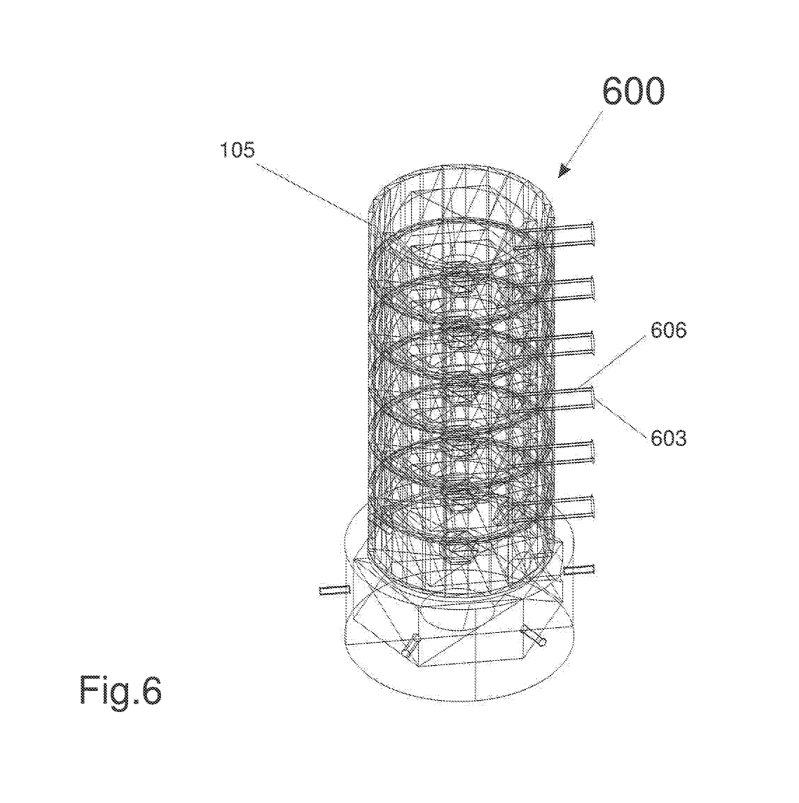

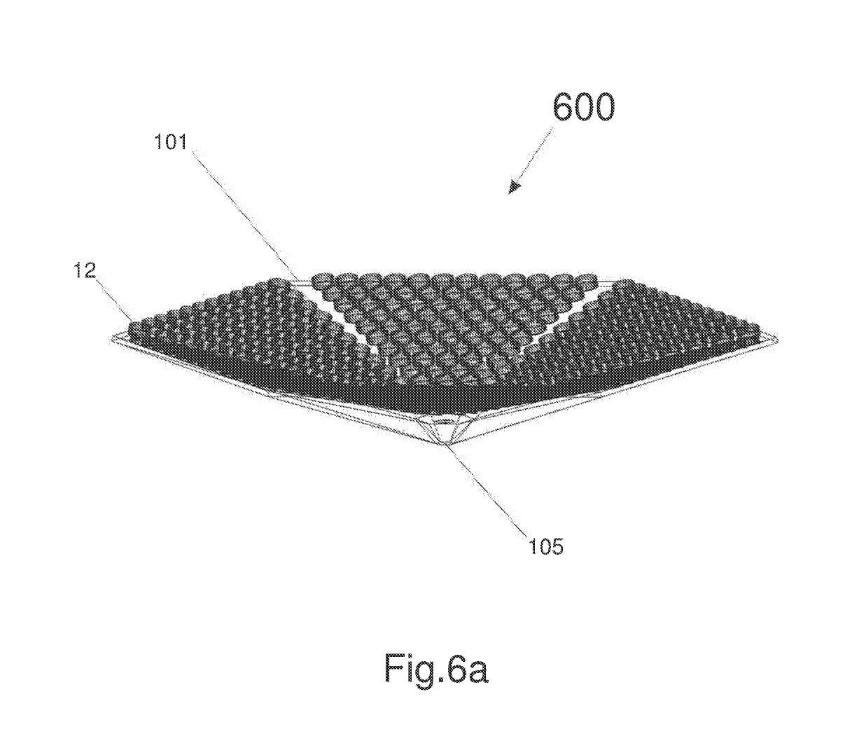

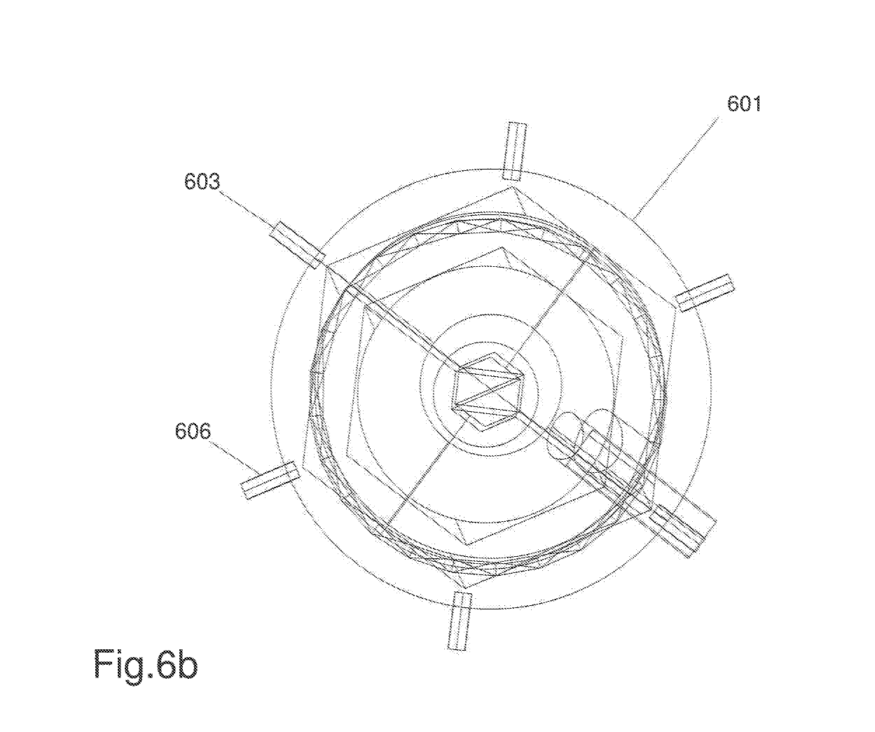

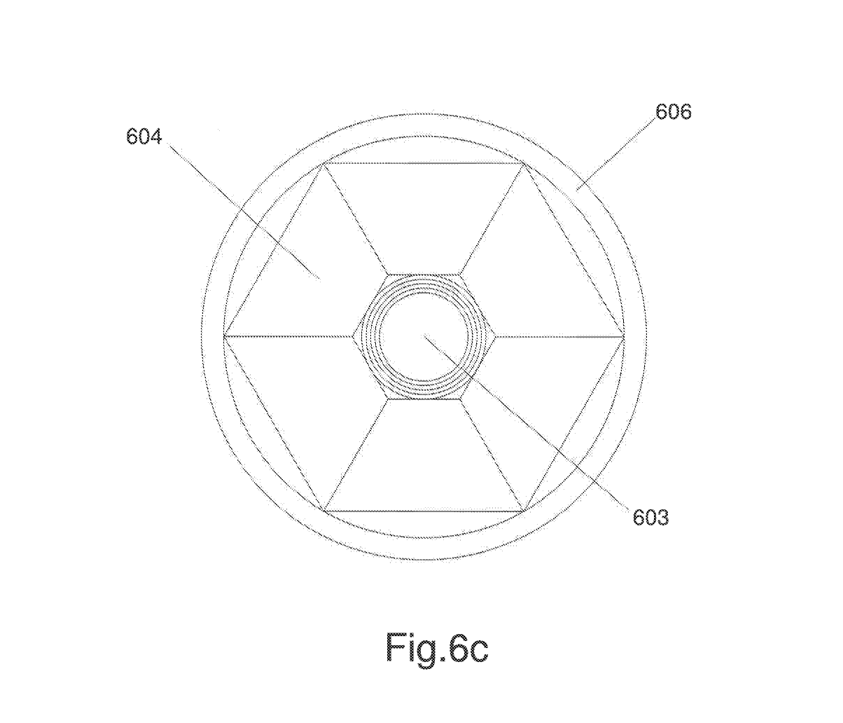

Exemplary FIG. 6 shows a see-through version of a collection shaft with water/light conduction tubes leading off of it.

Exemplary FIG. 6a shows an assembly of collector modules which may be used in conjunction with the shaft in exemplary FIG. 6.

Exemplary FIG. 6b shows a top-down view of the collection shaft of exemplary FIG. 6.

Exemplary FIG. 6c shows a view of an opening of one of the conduction tubes of exemplary FIG. 6.

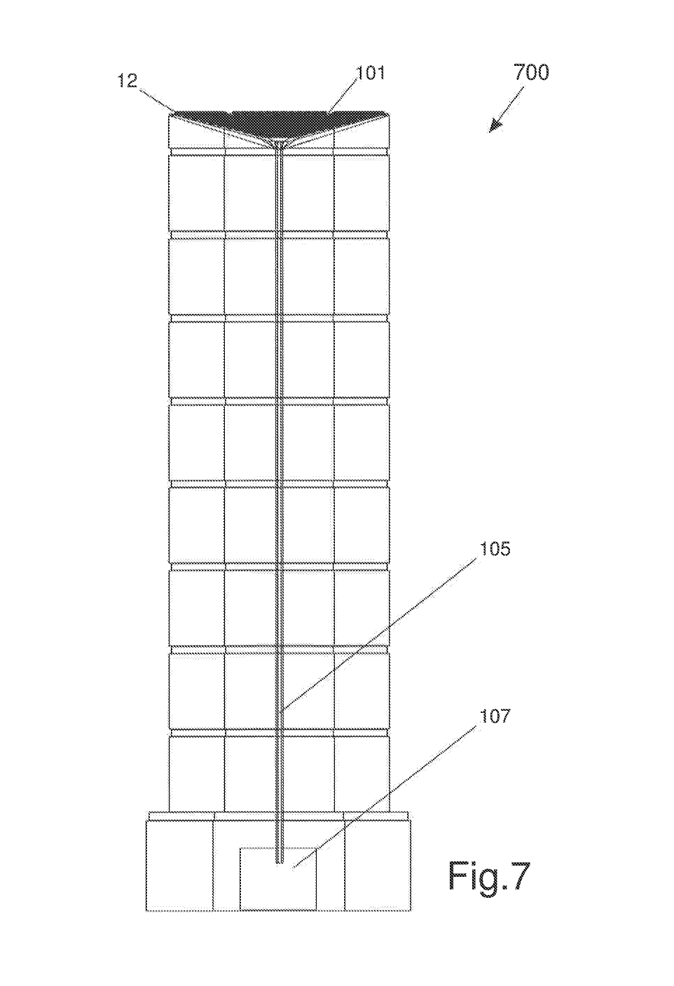

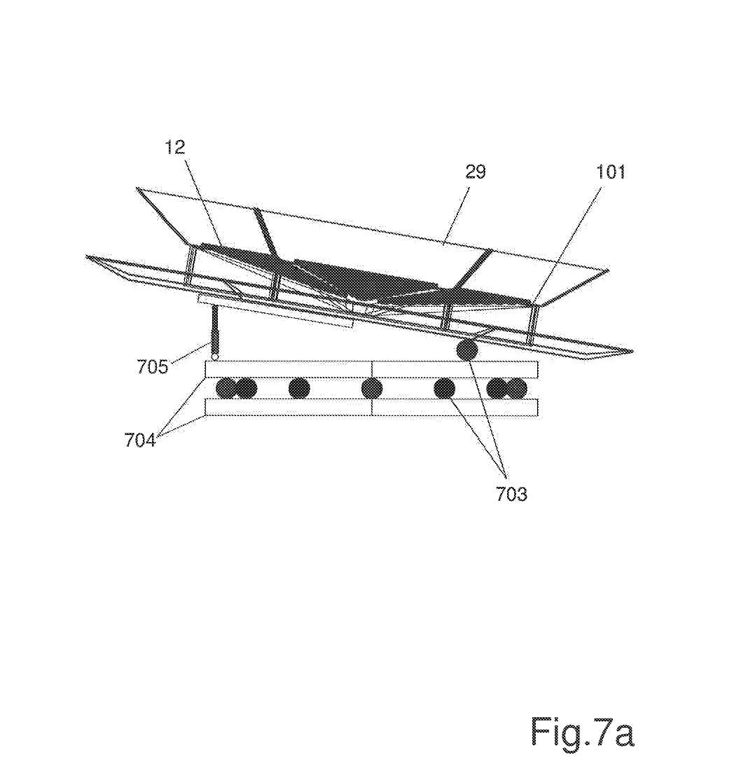

Exemplary FIG. 7 shows a side-view of a vertical farming high rise building.

Exemplary FIG. 7a shows a tracking system for use with an assembly of collector modules.

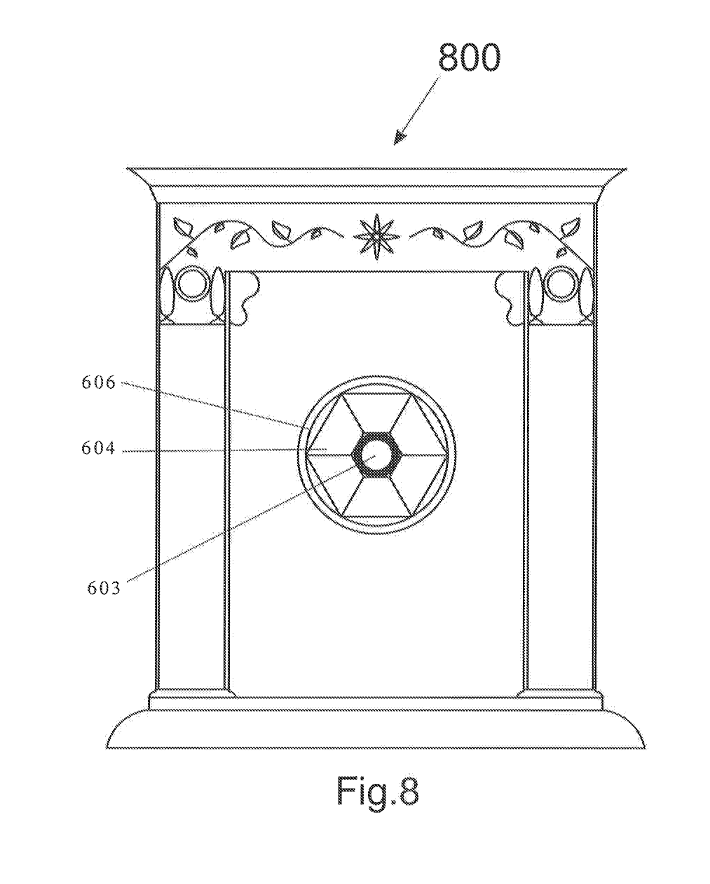

Exemplary FIG. 8 shows a stylized “light place.”

Exemplary FIG. 8a shows another schematic diagram of a field system incorporating multiple assemblies of collector modules.

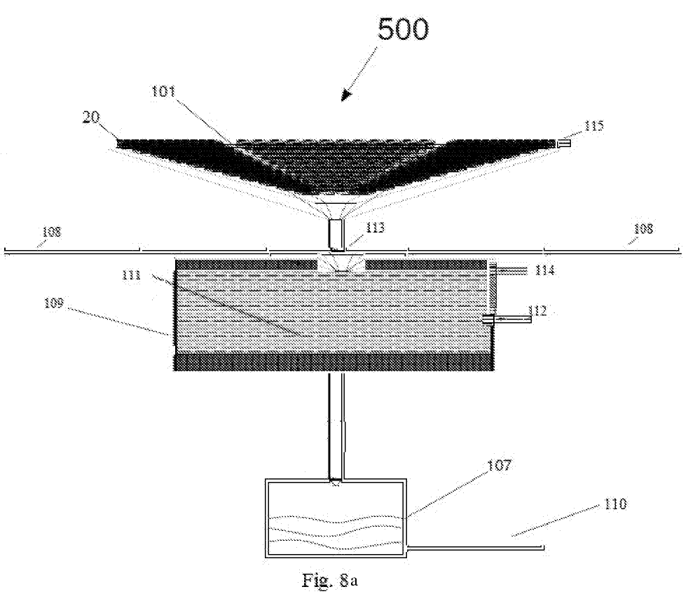

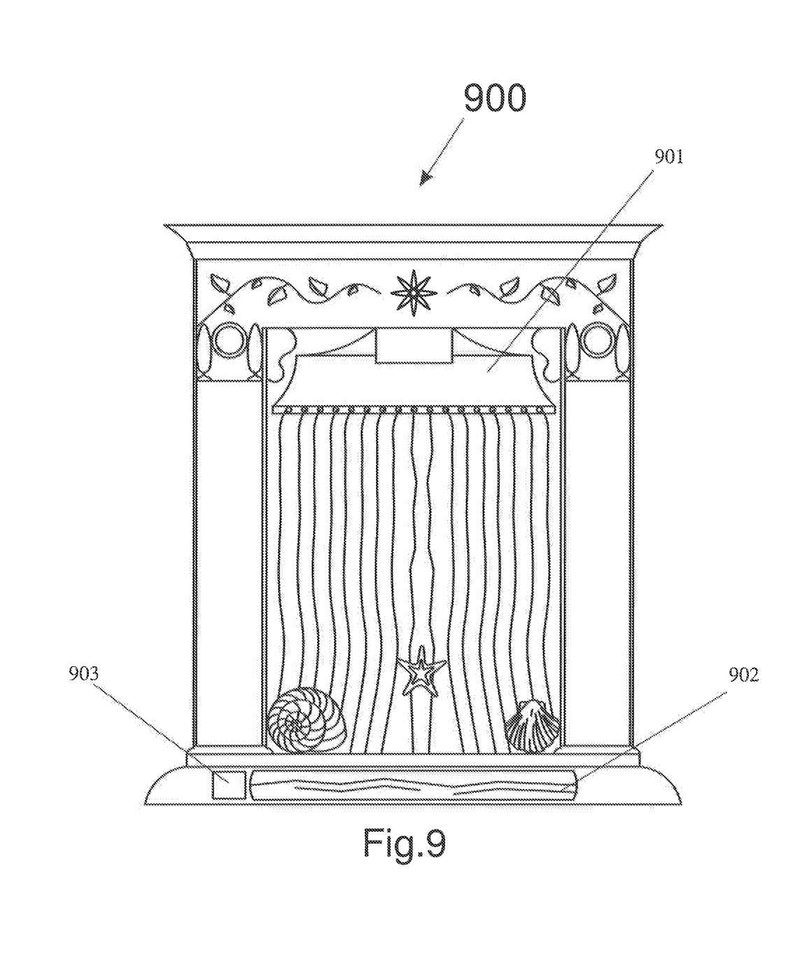

Exemplary FIG. 9 shows a stylized “water place.”

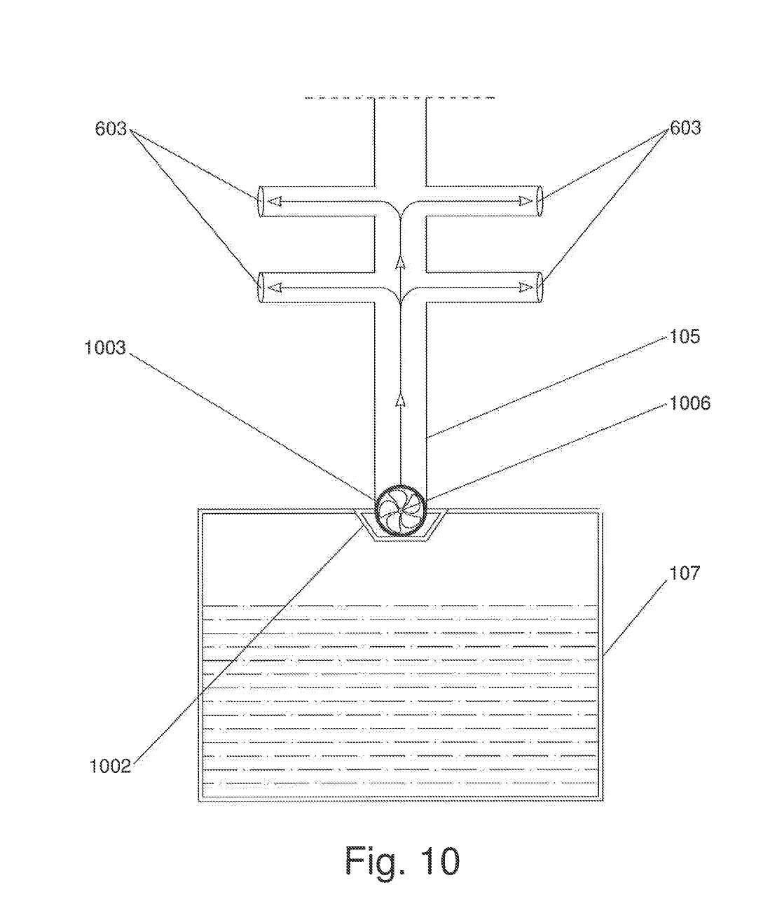

Exemplary FIG. 10 shows a cooling and ventilation system incorporated into the water storage tank and collection shaft of an embodiment similar to that as shown in exemplary FIG. 2.

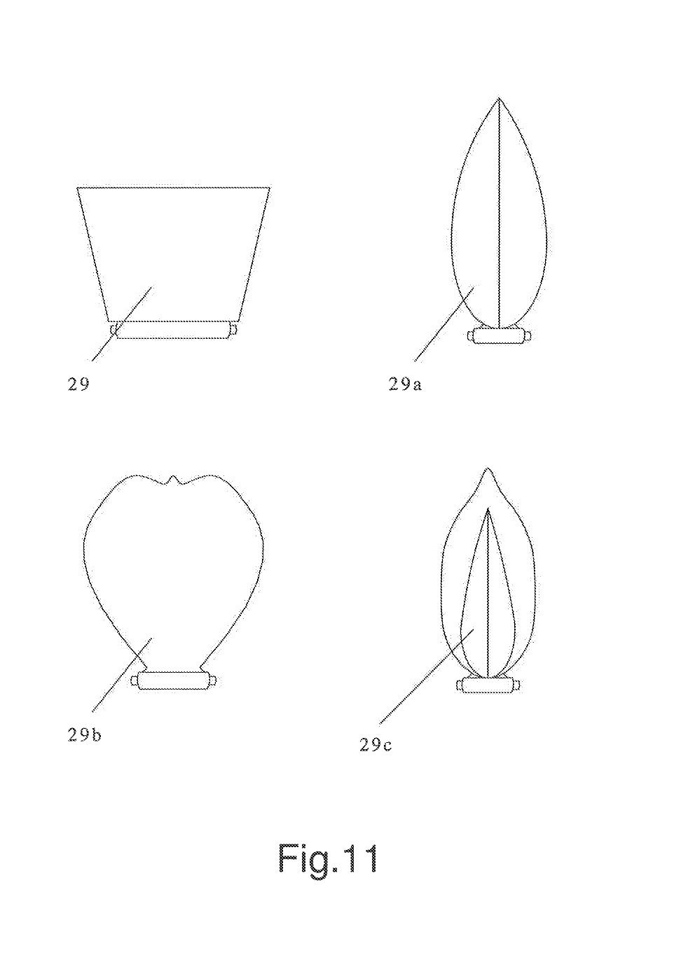

Exemplary FIG. 11 shows several possible designs for light-reflecting mirrors for use with an assembly of collector modules.

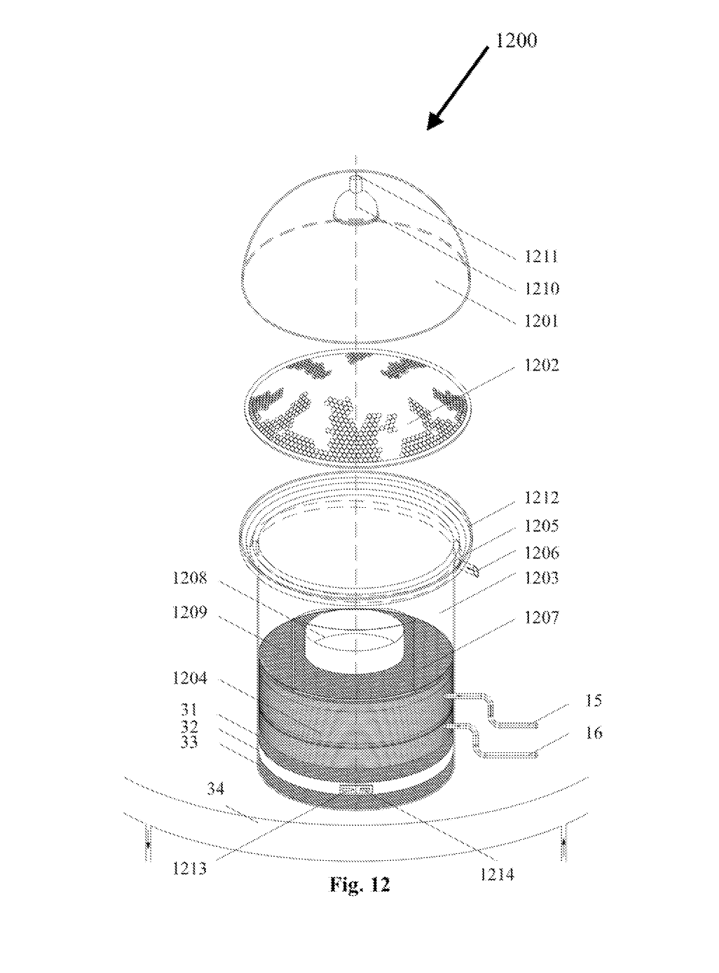

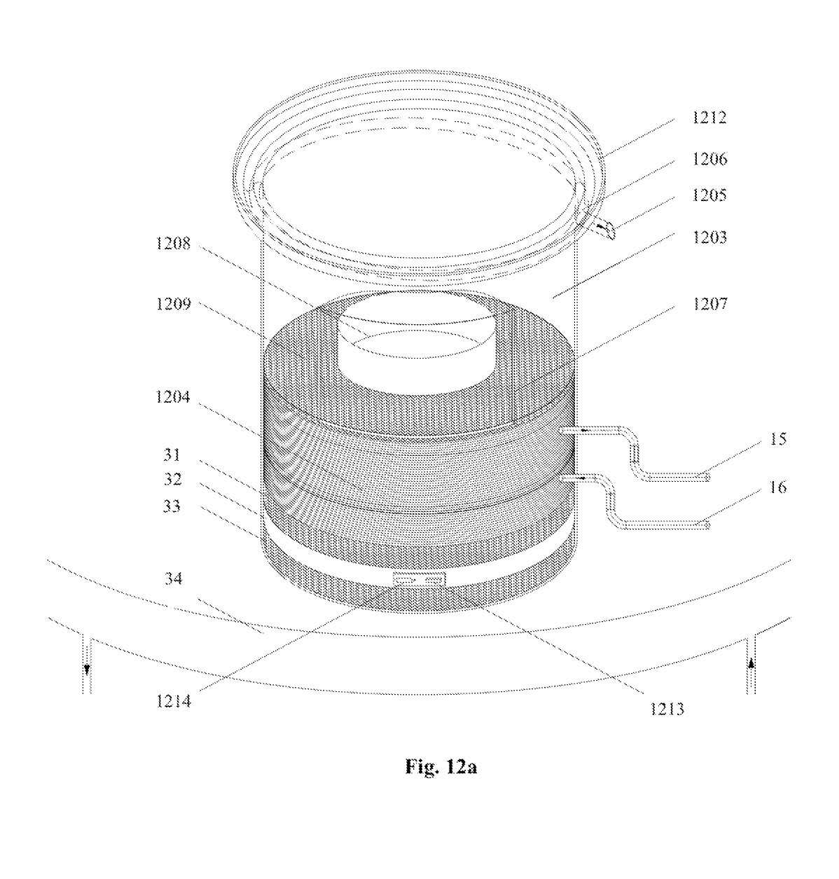

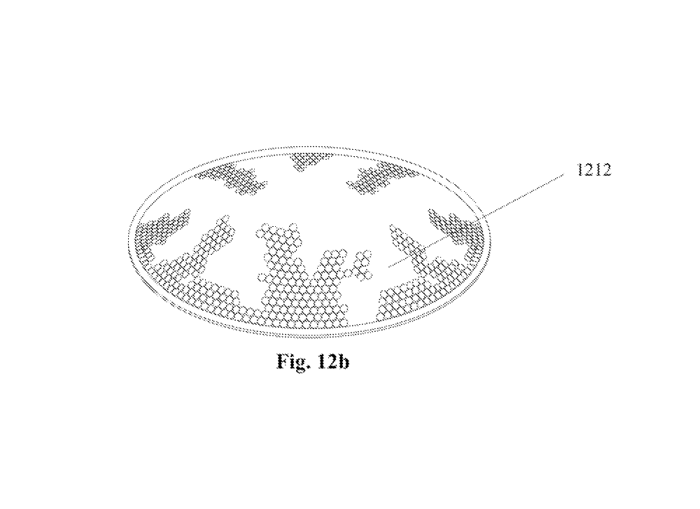

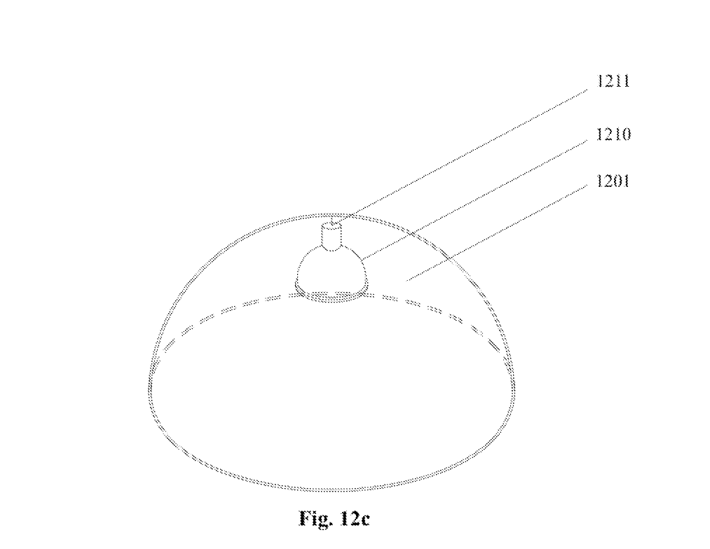

Exemplary FIG. 12 shows a perspective view of a solar house for solar energy coupled to a lighting system, a cooking module, and a thermal and electrical module.

Exemplary FIG. 12a shows a detailed view of the solar house without the cover on the top.

Exemplary FIG. 12b shows an assembly of micro lenses.

Exemplary FIG. 12c shows a detailed view of the semi-sphere cover.

Exemplary FIG. 13 shows a side-view of the assembly of the solar house of exemplary FIG. 12.

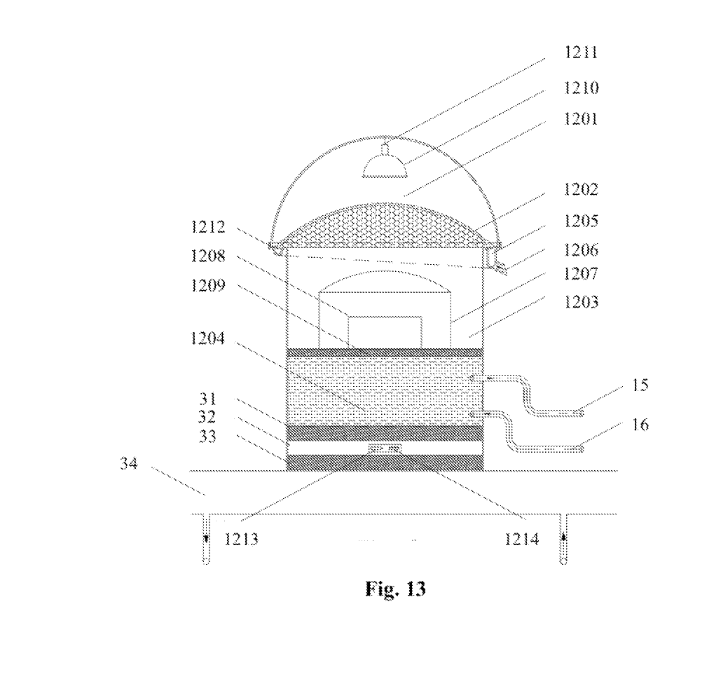

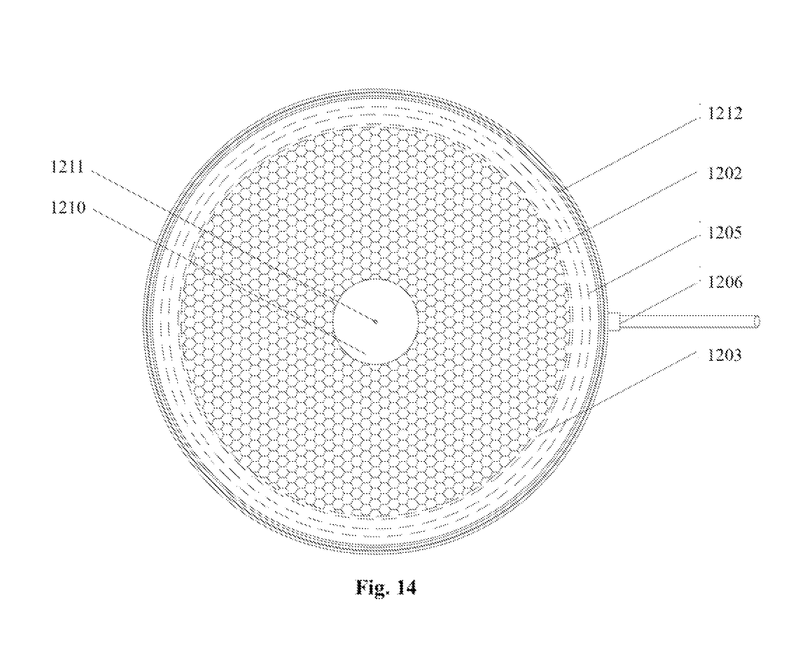

Exemplary FIG. 14 shows a top-down view of the assembly of micro lenses of exemplary FIG. 12b.

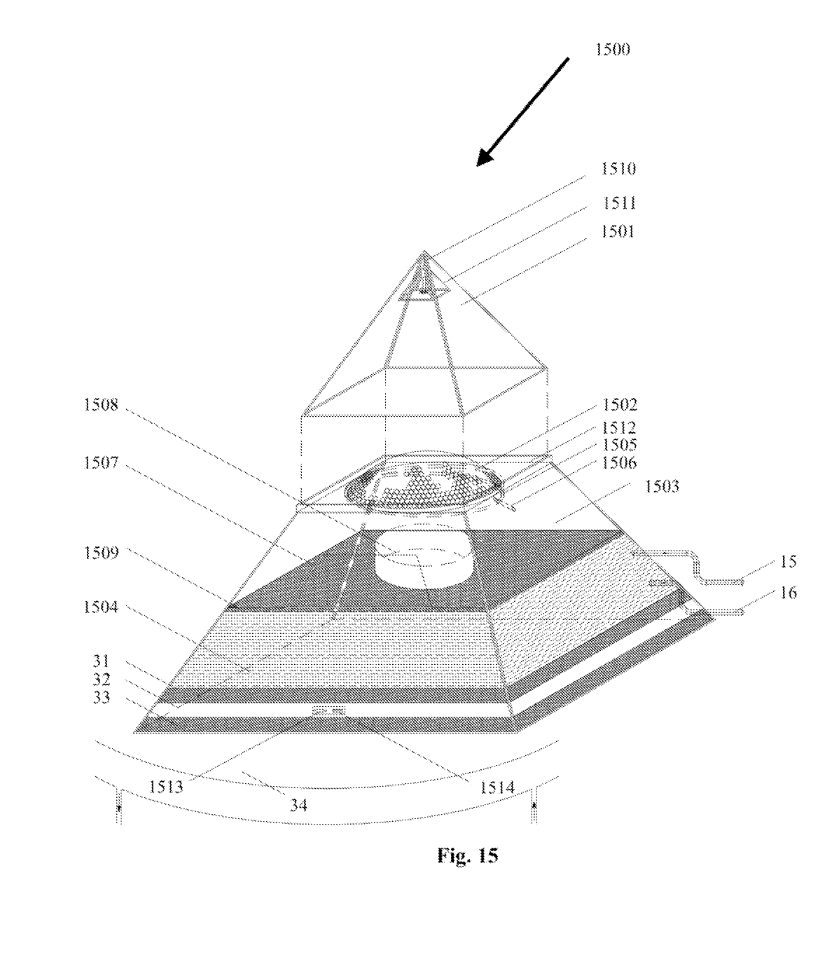

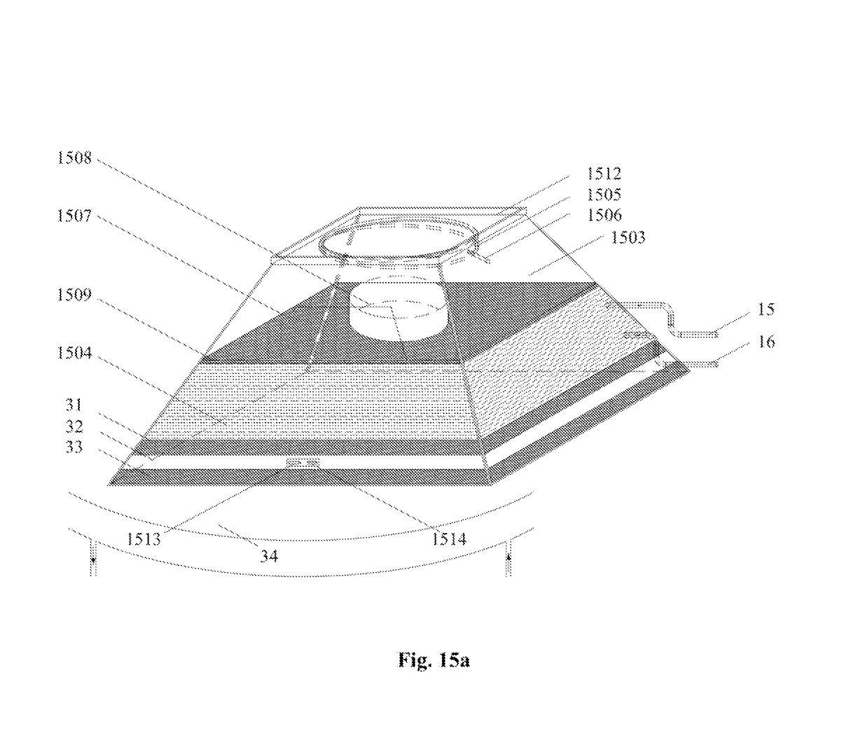

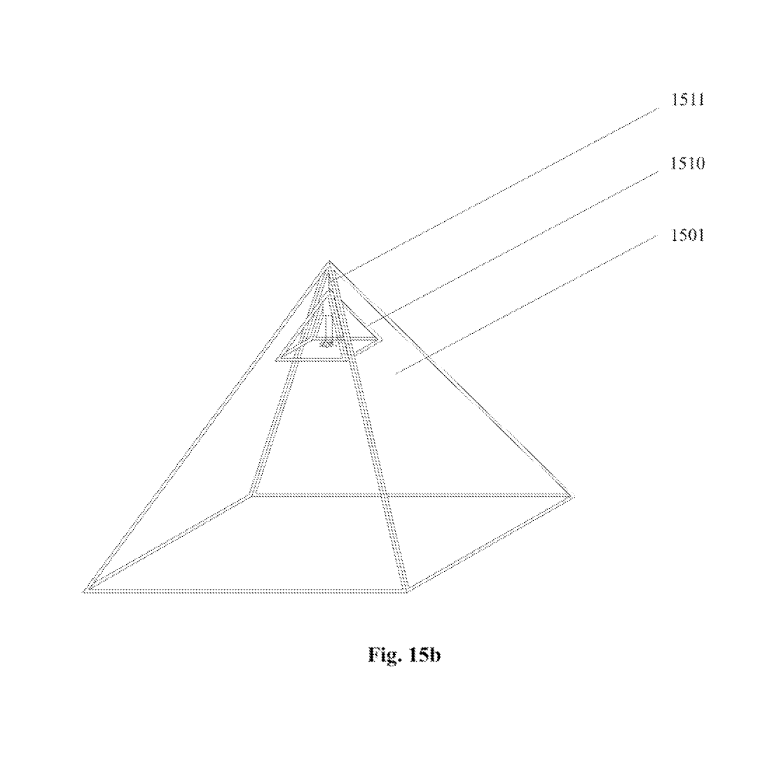

Exemplary FIG. 15 shows a possible design for an assembly of a solar house.

Exemplary FIG. 15a shows a detailed view of the solar house of exemplary FIG. 15 without a pyramid shaped cover on the top.

Exemplary FIG. 15b shows a detailed view of the pyramid cover.

Exemplary FIG. 16 shows a side-view of the assembly of the solar house of exemplary FIG. 15.

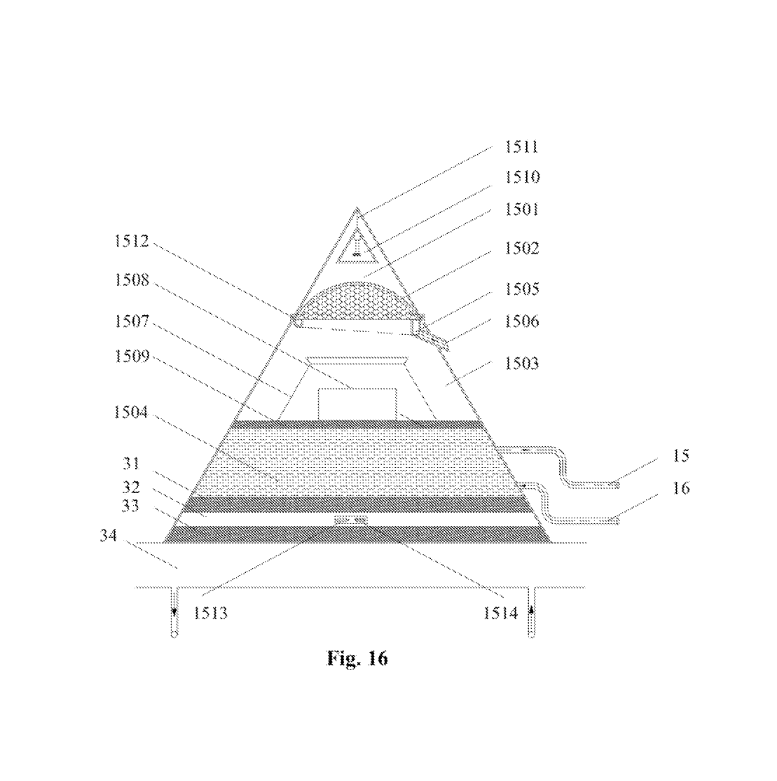

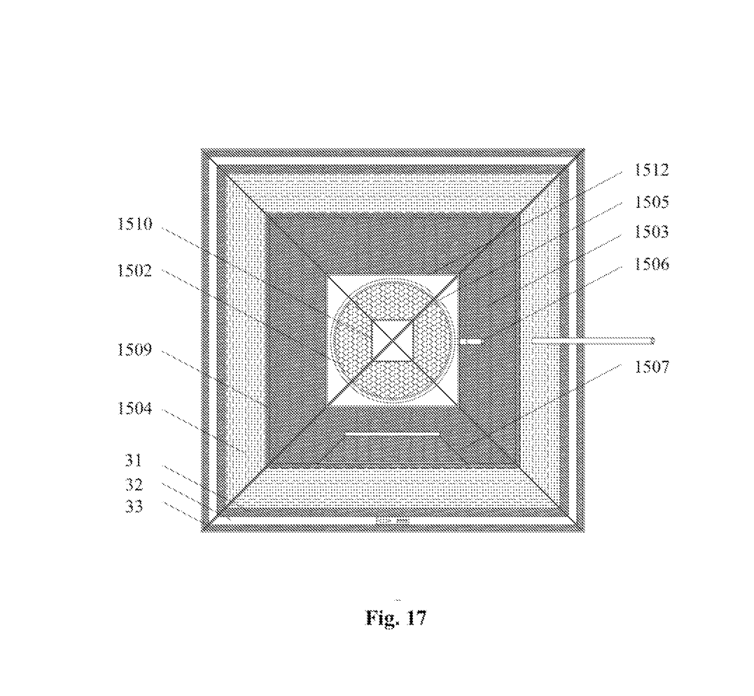

Exemplary FIG. 17 shows a top-down view of the assembly of the solar house of exemplary FIG. 15.

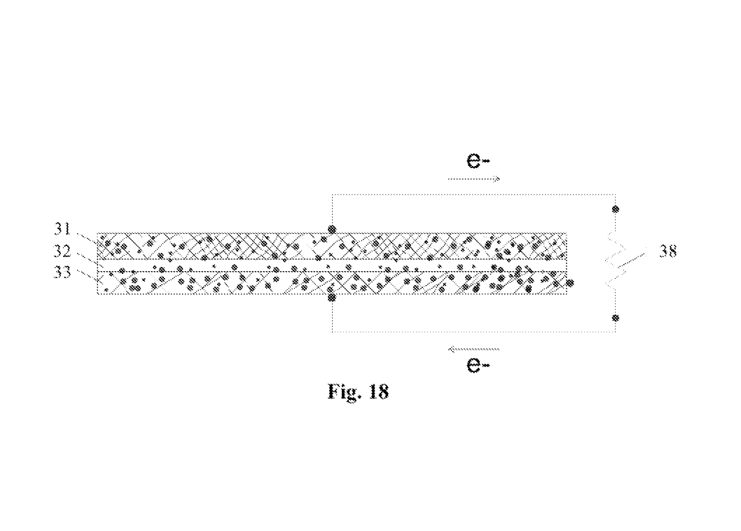

Exemplary FIG. 18 shows a cross-sectional view of an electrical system using thermocell.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to at least one exemplary embodiment, a system for collecting solar energy and fresh water may be disclosed. The system may include one or more assemblies of collector modules, each of which module may contain a photovoltaic cell and a thermal fluid. The thermal fluid may be used to heat a building and/or produce electricity. The assembly may further be coupled to a collection shaft which may collect water and/or disseminate light through a building. Various configurations of single modules, single assemblies, or multiple large-scale assemblies are also possible. If integrated with a house, the system may reduce the net energy consumption of the household.

Referring to exemplary FIGS. 1 and 1a, a collector module 10 for solar energy may include a concentrating lens 11, a solar photovoltaic (PV) cell 30, and a thermal container 12. Concentrating lens 11 may as thick or as thin as desired for a particular application. Concentrating lens 11 may further be constructed of an acrylic thin-film material, or as desired. Lens 11 may further be constructed of a multiple-micro-lens material. According to one non-limiting example, lens 11 may be constructed of an acrylic thin-film material with a thickness of approximately 0.3175 cm. Additionally, lens 11 may be colored or colorless, as desired, for example to enhance its aesthetic quality, and/or lens 11 may be in any shape, for example a hexagonal shape. PV cell 30 may be located proximate to the focal point of lens 11. Thermal container 12 may be located below lens 11. For example, PV cell 30 may be located on the top exterior surface of thermal container 12. Thermal container 12 may further be painted black. Lens 11, PV cell 30, and thermal container 12 may be constructed in a 1:1 ratio for every collector module 10, or multiple lenses 11 may be employed for a single thermal container 12, as desired.

According to one non-limiting example, one or more collector modules 10 could be affixed to the roof of a building, for example the roof of a house, to provide solar energy collection for the building. Lens 11 may be coated with a water- and particulate-resistant material to protect the integrity and functionality of collector module 10.

In the use of collector module 10, exemplary temperatures may reach 700-800° Celsius. A thermally-conductive fluid 40 may be used in thermal container 12 to capture and absorb the heat created by concentrating lens 11. Thermally-conductive fluid 40 may be for example molten salt, thermally-conductive oil, or as desired. Fluid 40 may be conducted to and from container 12 through feeder tube 16 and drainage tube 15. Where multiple thermal containers 12 are used in a single application, thermal containers 12 may be connected in parallel or in series through feeder/drainage tubes 16/15, as desired. Feeder tube 16 and drainage tube 15 may allow thermally-conductive fluid 40 to flow in a closed-loop system to transfer the heat energy elsewhere to perform work, for example to heat a building or to heat water to produce steam to drive a turbine-generator for electricity, or as desired.

According to at least one exemplary embodiment, an application of collector module 10 can produce electric energy of at least 0.45 KW/m2 and at an efficiency of at least 90%.

Referring now to exemplary FIG. 2, a solar house 100 may include a concave roof assembly provided with a plurality of interconnected thermal containers 12 holding a thermally conductive fluid in fluid communication with feeder tube 16 and drainage tube 15. Water- and light-collecting shaft 105 may pass downward through floors 103 of solar house 100 and may terminate below the ground line 109 within a basement. Shaft 105 may cause water to flow through the building into a water-collection container 107.

As solar energy is absorbed by the fluid in thermal containers 12, the fluid may be transferred down by drainage tube 15 to the basement of solar house 100. There may be temperature sensors (not shown) that would, when desired, allow the heated fluid to circulate within the building at each floor 103. When the temperature inside the building is sufficiently high, the heated fluid may flow to a system of storage tanks 17, 18. From storage tanks 17, 18 the fluid may be pumped into the floors at night to heat the building, or may be used in a steam-turbine generator (not shown) for electricity generation, or as desired.

Exemplary FIG. 2a shows an alternative design of the embodiment shown in FIG. 2, in such a way that the assembly would work as a solar thermoelectric battery or solar battery recharger, in which all auxiliary parts are eliminated like lighting semi sphere 17, gutter 13, contact canal 14, water collecting pipe 18, opening 19, pot 11, switch 23 and inlet and outlet tubes 15 and 16. Said solar thermoelectric then battery 20 may be connected through socket 24 either in parallel or in series as amount of power needed. Further, the assembly may be built as either a miniature solar battery of about one inch in height, for example a AAA small battery, or as very large about 10 m in diameter micro-lenses component 10 in order to store in conjunction with wind or photovoltaic field application. At any rate said solar thermoelectric battery may be exposed to sun rays at all times during day time in order to be recharged.

Exemplary FIG. 3 shows one non-limiting embodiment 300 of a set of six thermal containers 12, each with a concentrating lens, connected in parallel. Each thermal container 12 may contain a thermally-conductive fluid which may further flow through feeder and drainage tubes 16/15, as substantially described above. The fluid may flow to a heat exchanger 14, where it may heat another fluid, for example water/steam, to be used in a steam-turbine generator (STG) 19. Steam condenser 26 may collect outgoing cool air from STG 19 and transfer it back to heat exchanger 14. At night, the thermally-conductive fluid may be transferred to a storage container 17 containing a heat-storage material, for example molten salt. From storage container 17, feeder tube 16 may draw the thermally-conductive fluid back to thermal containers 12 for re-heating.

Exemplary FIG. 4 illustrates another non-limiting exemplary embodiment 400 wherein a concave assembly 101 holding a plurality of solar energy collecting modules and/or thermal containers, as shown in exemplary FIGS. 1-3 and described above, is further fitted with at least one mirror 29. Mirror 29 may be hinged to concentrate solar energy onto assembly 101, and may be adjusted throughout the day or year to maximize the efficiency of the solar energy collecting modules and/or thermal containers.

Now referring to exemplary FIGS. 5-5b, a field system 500 utilizing a plurality of solar energy- and/or water-collecting assemblies 101 may be disclosed. Field system 500 may be designed or adapted to work in various environments. For example, in a desert application, a water- and particulate-resistant coating on each lens used together with a concave shape of each assembly 101 may allow water and sand to slide off the lenses. Water can then be filtered and collected separately, such as in container 107. This is an advantage because conventional projects may develop a plaque-like substrate that deposit on the lower part of such conventional parabolic mirrors, and must be cleaned frequently.

Each assembly 101 may be concave and formed in any shape, for example, hexagonal. Each assembly 101 may further be coupled to a mirror 29 which may assist in the efficiency of the collection of solar energy. Each assembly 101 may also be coupled to a collecting shaft 105 for water or any other matter which may fall upon the surface of assembly 101.

A thermally-conductive fluid may travel in a closed-loop system to and from assemblies 101 by way of feeder and drainage tubes 16 and 15, respectively. Heated fluid may be taken from assemblies 101 by way of drainage tube 15 to one or more heat exchangers 14, 26, and/or 27. Heat exchanger 14 may provide access to one or more thermal storage containers 17 and 18. The flow of heat to and from thermal storage containers 17, 18 may be controlled in part based on time of day. For example, heat may be stored in the containers during the day to be used later at night. Additionally, the stored heat may be transferred back into the system at night to maintain a desired viscosity in the fluid, for example when using molten salt. Heat exchanger 26 may be used to heat water or water vapor into steam, which may be used in STG 19 to produce electricity. Spent vapor from STG 19 may then flow to a heat exchange loop including a heat exchanger 27 in fluid communication with an air cooled condenser 25, further cooling and condensing the water, after which it may return to heat exchanger 26.

According to one non-limiting example, field system 500 may be a stand-alone solar power system. Field system 500 may also be integrated with a building or other structure to provide electricity and/or heat to the building or structure.

Additionally, PV cells may be integrated with the thermal containers 12 in a fashion similar to as shown in FIGS. 1 and 1a, and as described above. The PV cells may be connected together and thereby form an additional electricity source for field system 500. A high-temperature resistant PV material may be used, for example, gallium arsenide (GaAs), or as desired.

Each assembly 101 may be coupled to a collection shaft 105 which may further lead to a storage container 107. A filter 503 may be placed proximate to the bottom portion of shaft 105. Filter 503 may be, for example, a semi-permeable membrane through which water may flow but particulate matter may not flow. The water may then fall to a purifying filter 504 before entering container 107. Located proximate to filter 503 may be a door 502 operated by a sensor 501 by way of an opening mechanism 505. Sensor 501 may detect for an accumulation of particulate matter, and when a threshold level has been reached, door 502 may be opened to allow the particulates to drop out. Alternatively, door 502 may remain open at all times, allowing particulates to continuously drop out of shaft 105.

Exemplary FIGS. 6, 6a, and 6b show a distribution system 600 for water and light which can incorporate solar-energy collection assembly 101 utilizing thermal containers 12. Collection shaft 105 may be coupled proximate to the bottom of a concave assembly 101, which itself may be affixed to the roof of a building, to collect water and light and distribute it to different parts of the building. One or more conducting tubes 606 may lead from shaft 105 to different parts of the building, for example to each floor or to each room, where there may be openings 603 through which water and/or sunlight may pass. Light may be reflected or conducted through tubes 606 using mirrors or a fiber optic system, or as desired. Water may flow through tubes 606 using gravity or pumps, or as desired. Shaft 105 may additionally have an outer shell 601, which may have an aesthetically pleasing cylindrical shape.

Exemplary FIG. 6c shows a cross-sectional view of a tube 606, as described above, with an opening 603. Mirrors 604 may be placed around opening 603, which may scatter or spread the entering light, thereby causing it to more efficiently brighten the interior area.

The advantages of this embodiment may be realized when installed by itself or as integrated with a building. For example, when integrated with a residential building, either single-family or a multi-family apartment building, the energy consumption of each affected household may be decreased. Additionally, the calming effects of a light place or a water place may be integrated with this embodiment as further described below.

Exemplary FIG. 7 shows a non-limiting exemplary embodiment of a vertical farming high rise building 700 which may incorporate a solar-energy collection assembly 101 utilizing thermal containers 12. Collection shaft 105 may conduct collected rain water down through building 700 to a storage container 107. In the event water is needed in a part of building 700, water may be diverted in a manner similar to as described above and shown in exemplary FIG. 6, or water may be pumped up from container 107, as desired.

Now referring to exemplary FIG. 7a, a tracking system may be utilized with any of the above-described embodiments incorporating solar-energy collection assembly 101 utilizing thermal containers 12. At least one mirror 29 may be coupled to collection assembly 101 to concentrate the solar light. A pair of base structures 704 may support collection assembly 101 over a bearing system 703. Bearing system 703 may allow collection assembly 101 to rotate. A piston 705 may be coupled to collection assembly 101 and one of base structures 704, which may allow collection assembly 101 to tilt to various angles. Bearing system 703 and piston 705 may allow collection assembly 101 to be mounted on roofs with different pitches, or on the exterior wall of a structure, and continually track the sun as its position changes over the course of the year or a single day.

Exemplary FIG. 8 shows a stylized representation of a light place 800, incorporating a conducting tube 606, opening 603, and mirrors 604, as shown in exemplary FIG. 6c and described above. Light place 800 may be a decorative output for light conducted by conducting tube 606, and may be designed to be aesthetically pleasing, for example in the shape of a fireplace, and may provide light to an interior room of a building.

Referring now to exemplary FIG. 8a, there may be shown a modification of the embodiment shown in FIG. 5a in such a way that container 20 could be used in a reduced form as a solar thermoelectric battery connected in series as shown here in FIG. 2a. Thus, FIG. 8a shows these solar thermoelectric batteries connected in series inside the original solar disk 101. The solar thermoelectric batteries could then generate enough current for the operation of a conveyor disk 108, just below main solar disk 101, that would collect and lead waste plastic on sea/ocean surface into a grinder 113 and large container tank 109 in which there will be plastic digesting bacteria species 111 as will be described below.

Still referring to exemplary FIG. 8a, tank 109 which has a form like a donut (buoyant-like) can also have the function to keep the solar disk 101 floating at least 10 meters above the surface of the sea/ocean, which may have large dimensions equal/greater than about 40-100 meters in diameter, in order to avoid salt seawater going inside disk 101. On both sides of said lower disk 108 there are electrically operating conveyors that conduct collected plastics into a grinder 113 and then into plastic digesting bacteria filled tank/ buoyant 109. The conveyors 108 may be attached in an inclined fashion (not shown) in such a way that it is 5-7 meters above the sea level in order to collect the plastic, relatively dry, into the grinder 113 without seawater

Further, in exemplary FIG. 8a, condensed water collected from solar disk's 101 hydrophobic surface could be led into container tank 107 that could be pumped out to shore through tube 110 or collected otherwise when filled.

Thus, in exemplary FIG. 8a, the solar plastic collection disk 108 could function as follows: on top of the solar disk, solar energy in form of solar heat is converted into electricity via photo switchable molecules and thermocell layers, as described above in FIGS. 2 and 2a. The solar disk surface is treated with a lubricant material that can absorb and condense water droplets from the atmosphere (see, for example, Aizenberg et. al. in nature 2016: doi:10.1038/nature16956, which is hereby incorporated by reference). The lower disk 108 just under the main solar collectors 101 through said conveyors, collects plastic waste from the sea/ocean in order to then conduct into a larger container 109 filled with plastic digesting bacteria 111 (see, for example, Feeding on plastic, Science (2016). DOI: 10.1126/science.aaf2853, which is hereby incorporated by reference) that then can be collected and brought also to shore through tube 112 together with collected condensed fresh water via tube 110. Plastic digesting bacteria would then also be replaced and injected through tube 114. Said solar disk is also equipped with a GPS sensor 115 to locate the floating SOPC at any time and place on the ocean/sea in case it is not fixed near shore or a town's port.

Around the circumference of the lower edge of the lower conveyor disk 108 there may be a series of hanging network of baskets full of oyster seeds, clams, scallops and sea mussels (not shown); in between kelp seaweeds grown on robs that may create a vertical farming assembly system (not shown) to generate food and harness the ocean for food needed around the world. The SOPC hence can be used not only to collect toxic plastic deposed waste from the sea using its own generated electric energy to operate the conveyers 108 as shown in FIG. 8a, but at the same time generate healthy food for humans. For example, according to the UN Health Organization and European Food Information Council, Kelp seaweed is one of the few vegetables that contain vitamin B-12, which is important for a healthy nervous system. Kelp seaweed is a good source of vitamin A. Kelp and other types of seaweed contain measurable amounts of vitamins C, E and K, as well as niacin, folate and choline. With the surplus collected plastics that cannot be directly digested by bacteria within our device SOPC we arranged with AutoDesk Microsoft so-called “Protocycler” 3D printer that can recycle waste plastics into filaments that may be then used in this 3D printer to shape build our micro-lenses producing more SOPCs in a closed manufacturing cycle. See video https://www.youtube.com/watch?time_continue=235&v=3-EY8I_XonY, which is hereby incorporated by reference.

Exemplary FIG. 9 shows a stylized representation of a water place 900. Water place 900 may be a decorative output for water conducted by conducting tube 606 and may be designed to be aesthetically pleasing, for example in the shape of a fireplace, and may provide a calming waterfall to an interior room of a building. The water for water place 900 may be provided via a conducting tube 606 as shown in exemplary FIG. 6 and described above. Water place 900 may include a fountain 901, a reservoir 902, and a pump 903. The power for pump 903 may be supplied by an in-building generator, for example a generator for which the power is supplied by a solar-energy collection assembly 101 and any of the above-described embodiments. The evaporation inherent in an open-water system such as water place 900 may also cool the room in which it is located, thereby reducing the need for other air-conditioning energy costs.

Exemplary FIG. 10 shows a cooling system using water collected in a storage container 107, for example as shown FIG. 2 and described above. A ventilator fan 1006 may move cool air from the top of container 107 through a filter 1002. The air may then be propelled by fan 1006 through shaft 105 and exit openings 603 into the interior of a building. The propelled air may thus cool the rooms into which it enters. A sensor 1003 may be installed at the fan 1006 to control the functioning of fan 1006, causing it to run or stop as desired. Fan 1006 may be powered by an in-building generator, for example a generator for which the power is supplied by a solar-energy collection assembly 101 and any of the above-described embodiments.

Exemplary FIG. 11 illustrates several non-limiting exemplary embodiments of a solar mirror 29 as described above. As shown in exemplary FIG. 11, the mirror may be a plate (29), a lotus flower design (29a), a rose petal design (29b), a sub flower petal design (29c), or as desired. Other designs for a mirror are also envisioned. Such flower-related designs may improve the aesthetic qualities of the solar-energy collecting assembly to which the mirror may be coupled.

Referring now generally to exemplary FIGS. 1-11, a variety of different configurations and usages are envisioned. A plurality of collector modules may be combined in a solar energy collecting assembly. The solar energy collecting assembly may further include one or more reflecting mirrors and/or a tracking system, and the assembly may be used individually or set up as a field of energy collectors. The heated thermal fluid from the collector modules may be used to heat an interior area and/or produce electricity. Also, a concave-shaped assembly may be used to collect water for other applications. Additionally, an open-structured water collection shaft may also be used to conduct light into the interior of a building.

Referring to FIG. 12, an exemplary solar house may include a cover 1201, an assembly of micro lenses 1202, a cooking module 1203, and a thermal and electrical module 1204. Cover 1201 may be constructed of an acrylic thin-film material, or another appropriate material, as desired. Cover 1201 may further be as thick or as thin as desired for a particular application. Additionally, cover 1201 may be colored or colorless, as desired, for example to enhance its aesthetic quality, and/or cover 1201 may be in any shape, for example a dome shape, as desired. The assembly of micro lenses 1202 may be affixed to cooking module 1203, or made detachable. According to one non-limiting example, micro lenses 1202 may be constructed of acrylic material, or the like, for example to resist high temperatures. Cooking module 20 may have a plastic or metal housing, and may be further painted with color or formed colorless, as desired, and it may further be detachable from the thermal and electrical module 1204, as desired.

Exemplary FIG. 12a shows a detailed view of the assembly of cooking module 1203 and thermal and electrical module 1204, without cover 1201. A water collecting system may be located on the top exterior surface of cooking module 1203, comprising a water collecting channel 1205 and a tube 1206. Water or any other matter which may fall upon the surface of micro lenses 1202 may be filtered and collected by channel 1205 surrounding the top surface of the outer shell of cooking module 1203, and may then be directed to tube 1206. According to one non-limiting embodiment, the water channel 1205 may be further inclined at 4° towards the out circle to facilitate the collection of the gained water droplets. Water may flow through tubes 1206 using gravity or pumps, as desired.

The solar house 1200 may incorporate a cooking module 1203 utilizing thermal energy stored in thermal and electrical containers 1204. An opening 1207 in cooking module 1203 may be introduced to allow entrance and exist of cooking pot 1208. When cooking pot 1208 is not in use, opening 1207 may be covered by a door. According to one non-limiting example, cooking pot 1208 may contain seawater, facilitating high temperature desalination and disinfection of water for safe human drinking and use. This is an advantage because conventional water collecting projects do not have the ability to collect and disinfect water using the same device.

A layer 1209 may be applied proximately to the focal point of lens 1202 to maximize the heat absorption of the solar heat. In one non-limiting example, the layer 1209 may be formed of carbon nanotubes (CNT) to maximize the absorption of the sunlight solar spectrum. The collected solar energy can be further stored inside a thermal and electrical module 1204 in heated thermal fluid to produce heat, and/or produce electricity. One or more feeder and drainage tubes 15/16, as substantially described above, may be coupled to thermal and electrical module 1204 to allow the heated fluid to circulate.

Alternatively, according to another non-limiting example, the solar energy may be stored inside the container 1204 using other material, for example photo switchable molecules (PSM). When PSM is used in an application, the tubes 15 and 16 may further be connected to a coiled spiral placed inside the thermal container for optimal heat conductivity.

Exemplary FIGS. 12b and 14 illustrate one non-limiting embodiment wherein a number of micro lenses 1202 are mounted to a supporting structure to collect solar energy. The micro lenses 1202 may be constructed from a translucent material group that includes glass, quartz, silica, plastics, and polymers. Alternatively, the micro lenses 1202 can be used in a light reflection configuration, in which non-translucent material may be used. For example, non-translucent materials may include silica and silicon, or reflective materials such as silver and gold. According to at least one exemplary embodiment, the thickness of the center of each lens may have a thickness of about 0.33175 cm and a width of about 0.040 mm. Each micro lens may further be adjusted at any angle. Additionally, lens 1202 may be coated with a water- and particulate-resistant material to protect the integrity and functionality of solar house 1200.

Referring now to exemplary FIG. 12c, a cover 1201 may include a lighting system 1210 connected to a wire 1211. The lighting system 1210 may include a plurality of small LED bulbs, or other lighting sources, as desired. A contact canal 1212, as shown in exemplary FIG. 14, may be added to cooking module 1203 to connect the power source to the said LED bulbs. A switch 1213, for example as shown exemplary FIG. 13 may further be included to control the lighting system 1210. Additionally, a socket 1214 may be added to charge devices using electrical DC current, for example, a Universal Serial Bus (USB) device, or as desired.

Exemplary FIG. 13 shows a side-view of the assembly of the solar house 1200, as shown FIG. 12, and described above. An assembly of micro lenses 1202 may be spherical in form, for example having a convex surface, to assist the efficiency of the collection of solar energy. Some advantages of this embodiment may be realized when used by itself at a fixed location. For example, when being placed in a desert area without easy access to human intervention, each micro lens 1202 on the convex surface can be arranged at an angle so that the focal point moves with the sun over the course of a day. Additionally, such a convex surface can facilitate the water collecting and make the water/rain droplets fall to water collecting channel 1205 easier.

Exemplary FIGS. 15, 15a, 15b, 16 and 17 show one non-limiting representation of a solar house 1500, incorporating a cover 1501, an assembly of micro lenses 1502, a cooking module 1503, and a thermal and electrical module 1504. The cover may be in pyramid shape, or any other shape or shapes, as desired. Similarly, cooking module 1503, and thermal/electrical module 1504 may be in shape of a pyramid with flat top, or any other shape or shapes, as desired. Other designs for a solar house are also envisioned. Such designs may adjust and improve the capability of each solar house depending on the individual application. For example, a pyramid-shaped thermal and electrical module may be utilized in the event of larger space is needed for larger thermal/electrical capacity.

Now referring to exemplary FIG. 18, an electrical module system having an upper plate 31 and a lower plate 33 separated by conductive material 32 may be shown and described. The upper plate 31 may be heated and the lower plate 33 may be cooled in order to increase the temperature difference Tₕ-T_{c} in between plates to increase thermocell's efficiency, where Tₕ is the temperature at the hot side metal and T_{c} is the temperature at the cold side metal. Plates 31 and 33 can be made of a carbon nanotubes thermocell material, such as electric current high efficiency that can be produced according to the equation: V=a (Tₕ−T_{c}), where V is the voltage difference produced across the terminals of an open circuit made of a pair of different metals, and “a” is Seebeck co-efficiency. The voltage or current produced across the junctions of two different metals is caused due to the diffusion of electrons from high electron density region to low electron density region as the density of electrons varies in different metals. The electricity produced during this process may further be integrated with lighting system 1210 to provide electricity and/or heat to thermal/electrical module 1204.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A solar energy and water collection system, comprising:
a plurality of solar energy collector modules, each of the solar collector modules comprising at least one micro lens, and the plurality of solar energy collector modules are coupled to a concave surface;
a thermally-conductive container that contains a thermally conductive fluid; and
an electrical module comprising metal plates separated by a semi-conductive material.

2. The solar energy collector system of claim 1, further comprising:
a cover, the cover located on top of each of the plurality of solar energy collector modules, the cover comprising a lighting system and a cable;
a cooking module comprising a cooking pot; and
at least two pipes fluidly connected to the thermally-conductive container, at least one of the pipes is an inlet for the thermally conductive fluid into the thermally-conductive container and at least one of the pipes is an outlet for the thermally conductive fluid out of the thermally conductive container;
wherein the thermally-conductive container absorbs heat energy from sunlight into the thermally conductive fluid,
wherein the absorbed heat in the thermally conductive fluid is transformed to electricity by the electrical module, and
wherein the electricity powers the lighting system.

3. The solar energy collector system of claim 1, wherein the cooking module has a water collection channel, and the water collection channel is fluidly coupled to the concave surface to collect water and conduct electric current to the lighting system.

4. The solar energy collector system of claim 1, wherein the at least one concentrating lens is coated with a protective material, wherein said protective material is resistant to at least one of water and particulate matter.

5. The solar energy collector system of claim 1, wherein the thermally conductive fluid is one of a thermal oil or a photo-switchable molecule.

6. The solar energy collector system of claim 1, wherein the metal plates are formed from carbon nanotube thermocell materials.

7. The solar energy collector system of claim 1, wherein the at least one micro lens is formed of an acrylic material.

8. A solar energy generation and storage device, comprising:
a housing;
a plurality of solar energy collector modules in the housing, each of the solar collector modules comprising at least one micro lens, and the plurality of solar energy collector modules are coupled to a concave surface;
a thermally-conductive container that contains a thermally conductive fluid;
an electrical module comprising metal plates separated by a semi-conductive material; and
a battery,
wherein the thermally-conductive container absorbs heat energy from sunlight into the thermally conductive fluid,
wherein the absorbed heat in the thermally conductive fluid is transformed to electricity by the electrical module, and wherein the battery stores the electricity.

9. The solar energy generation and storage device of claim 8, wherein the housing is about the size of a AAA battery.

10. The solar energy generation and storage device of claim 8, wherein the housing has a height greater than one meter.
